(19) United States
(12) Patent Application Publication
(10) Pub. No.: US 2003/0233285 A1
(43) Pub. Date: Dec. 18, 2003

(54) System and method for facilitating sales by way of mobile commerce

(76) Inventors: Fu-Yu Liu, Taipei (TW); Yi-Nan Li, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/308,632

(22) Filed: Dec. 2, 2002

(30) Foreign Application Priority Data
Jun. 13, 2002 (TW) 091112865

(51) Int. Cl. G06F 17/60

(52) U.S. Cl. 705/26

(57) ABSTRACT

A system for facilitating sales by way of mobile commerce includes a database server (101), a mobile commerce server (103) incorporating an application processing module (106), a client information system (110), and at least one mobile terminal (109). The database server stores information including client information and merchandise information. The application processing module is used to generate a business visit schedule based on data downloaded from the database server. Each mobile terminal downloads merchandise information from the database server and from the client information system. The mobile terminal includes an order processing module which is used to generate purchase orders based on merchandise data, and an executing data storing module which is used to record all information on business activities. The generated purchase orders are stored in the mobile commerce server. A related method for facilitating sales by way of mobile commerce is also disclosed.

### BACKGROUND OF THE INVENTION

1. Field of the Invention

The present invention relates to systems and methods for facilitating sales by way of mobile commerce, and more particularly to a system and method that automatically generates orders and sales analysis reports using a mobile terminal.

2. Description of Related Art

Traditional communication means such as letters, telephones, and faxes are used in a typical conventional business model. In such model, many people waste time on data collection and information transfer. Human error leads to serious mistakes being made, which can cause huge damage to an enterprise. There are also other difficulties including providing adequate technical support, high costs, and low customer satisfaction when mistakes occur.

Since the advent of wireless enterprise applications, new business models have appeared on the market. These business models alter the nature of a company's interactions with outside entities. Today, companies around the globe are realizing the benefits of using small wireless hand-held mobile devices, which have emerged as an ideal mobile sales assistant. With the ability of such mobile devices to access a company's data system and the advantages of portability and low cost of ownership, mobile electronic commerce is becoming increasingly popular and promises to further change traditional business models. Typically, mobile electronic commerce is conducted using a personal computer connected to the Internet via an Internet service provider. A wide variety of different commercial opportunities are thus made possible.

For example, U.S. Pat. No. 5,710,887 entitled Computer System and Method for Electronic Commerce discloses a business method to promote merchandise via the Internet. Firstly, an enterprise presents product promotion information on its website for customers to access. If a customer visits the website and chooses to view detailed information on a product, the enterprise's host computer promptly uploads the product's price and other detailed data to the customer's computer terminal for viewing. Accordingly, the customer can select a desired product and place orders on line. However, the commercial transaction takes place without any interactive communication between the customer and the enterprise. The customer cannot obtain further information on the product, and the enterprise cannot obtain detailed information on customers' product demands and related needs.

Accordingly, a new business model is desired to make communication between enterprises and clients faster and more accurate, to strengthen technical support, and to yield more client satisfaction. In such business model, sales representatives of the enterprise would use mobile computer terminals as sources of information instead of bulky, heavy and inconvenient paperwork.

### SUMMARY OF THE INVENTION

It is therefore an object of the present invention to provide an end-to-end system and method for generating purchase orders to assist promotion of merchandise using a mobile terminal.

Another object of the present invention is to provide a system and method for generating sales analysis reports to assist promotion of commercial activities using a mobile terminal.

In one aspect of the present invention, a system for facilitating sales by way of mobile commerce in accordance with a preferred embodiment of the present invention comprises a database server, a mobile commerce server incorporating an application processing module, a client information system, and at least one mobile terminal. The database server stores information including client information and merchandise information. The application processing module is used to generate a business visit schedule based on data downloaded from the database server. Each mobile terminal downloads merchandise information from the database server and from the client information system. The mobile terminal comprises an order processing module which is used to generate purchase orders based on merchandise data, and an executing data storing module which is used to record all information on business activities. The generated purchase orders are stored in the mobile commerce server.

In another aspect of the present invention, a method for facilitating sales by way of mobile commerce in accordance with the present invention comprises the steps of: (a) generating a computer advisory order in accordance with verified merchandise inventory information; (b) generating a sales representative advisory order in accordance with merchandise data and merchandise inventory information which is downloaded from a client information system; (c) generating a formal order in accordance with a quantity of merchandise and a category of merchandise which have been checked and/or modified; and (d) displaying a credit quota warning message. A further preferred step comprises: (e) compiling business visit information and generating an analysis report.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a system for facilitating sales by way of mobile commerce in accordance with a preferred embodiment of the present invention, the system comprising a database server, a mobile commerce server and at least one mobile terminal;

FIG. 2 is a schematic diagram of detailed infrastructure of the database server of the system of FIG. 1, and shows data communication between the database server, the mobile commerce server and one mobile terminal;

FIG. 3 is a schematic block diagram of function modules of one mobile terminal of the system of FIG. 1;

FIG. 4 is a flowchart of executing mobile commerce in accordance with a preferred embodiment of the present invention;

FIG. 5 is a flowchart of details of one step of FIG. 4, namely assisting execution of commercial activities;

FIG. 6 is a flow chart of promoting merchandise in accordance with the preferred embodiment of the present invention;

FIG. 7 is a flow chart of providing analysis reports in accordance with the preferred embodiment of the present invention;

FIG. 8 is a flow chart of details of one step of FIG. 6, namely generating a sales representative advisory order; and

FIG. 9 is a flow chart of details of another step of FIG. 6, namely displaying a credit quota warning message.

### DETAILED DESCRIPTION OF THE INVENTION

Preferred embodiments of the present invention will now be explained by use of the accompanying drawings.

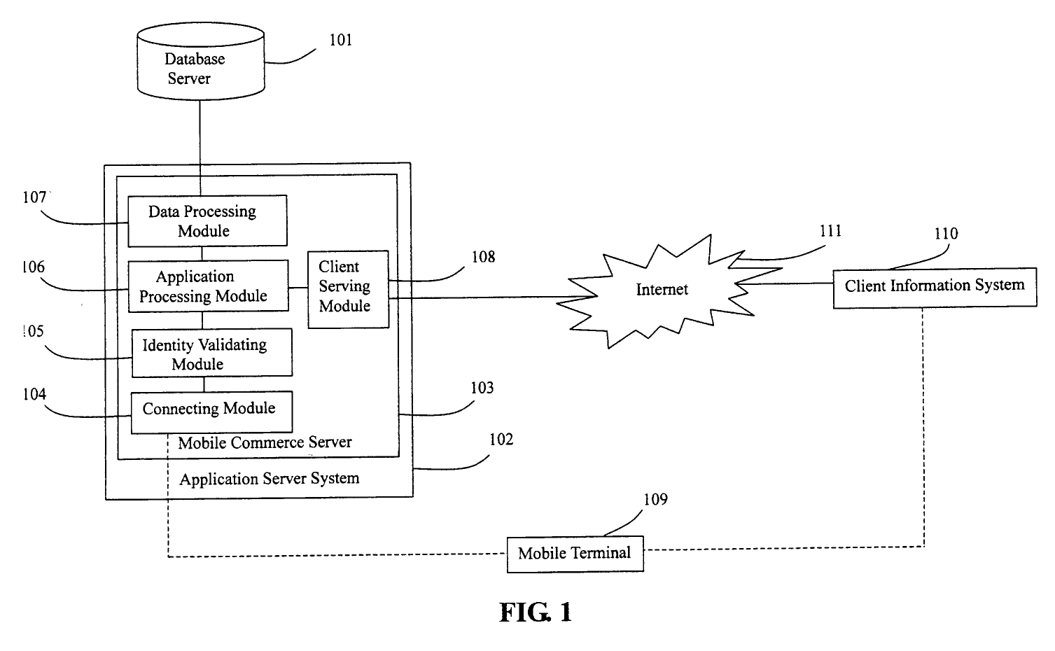

FIG. 1 is a schematic diagram of a system for facilitating sales by way of mobile commerce in accordance with a preferred embodiment of the present invention. The system for facilitating sales by way of mobile commerce comprises a three-tier information system. The three-tier information system comprises a database server 101 (the bottom tier), an application server system 102 (the middle tier), and a plurality of distributed terminal workstations 109 (the top tier, only one shown). The application server system 102 of the preferred embodiment comprises a mobile commerce server 103. Each terminal workstation 109 of the present invention is a mobile terminal 109, which can be a Personal Digital Assistant (PDA), a pocket personal computer (pocket PC), a laptop computer, a palmtop computer, a smart phone or a notebook computer. A client information system 110 connects with each of the mobile terminals 109 via a cable, infrared signals, or wireless communications. Each mobile terminal 109 connects with the mobile commerce server 103 via a cable, infrared signals, or wireless communications. The mobile commerce server 103 connects with the database server 101, and is used for generating business schedules in accordance with data stored in the database server 101. The mobile terminal 109 downloads a business schedule from the mobile commerce server 103, for assisting execution of commercial activities. The mobile terminal 109 shows steps of required commercial activities in accordance with the business schedule, records data on execution of commercial activities, and uploads data on transactions and on execution of commercial activities for updating of data stored in the client information system 110.

The mobile commerce server 103 comprises a connecting module 104, an identity validating module 105, an application processing module 106, a data processing module 107, and a client serving module 108. The connecting module 104 connects with the mobile terminal 109, and is used for transferring data between the mobile terminal 109 and the mobile commerce server 103. The identity validating module 105 checks identities of personnel such as sales representatives, and distributes various business schedules to various sales representatives. The application processing module 106 creates business schedules for every sales representative in accordance with data stored in the database server 101, and updates data stored in the database server 101 in accordance with data sent from the mobile terminal 109. The data processing module 107 connects with the database server 101, and transfers data between the database server 101 and the mobile commerce server 103. The client serving module 108 connects with the client information system 110 via the Internet 111. The client serving module 108 sends information on mobile commerce to clients, and receives data on cooperating with clients and data on requirements of clients.

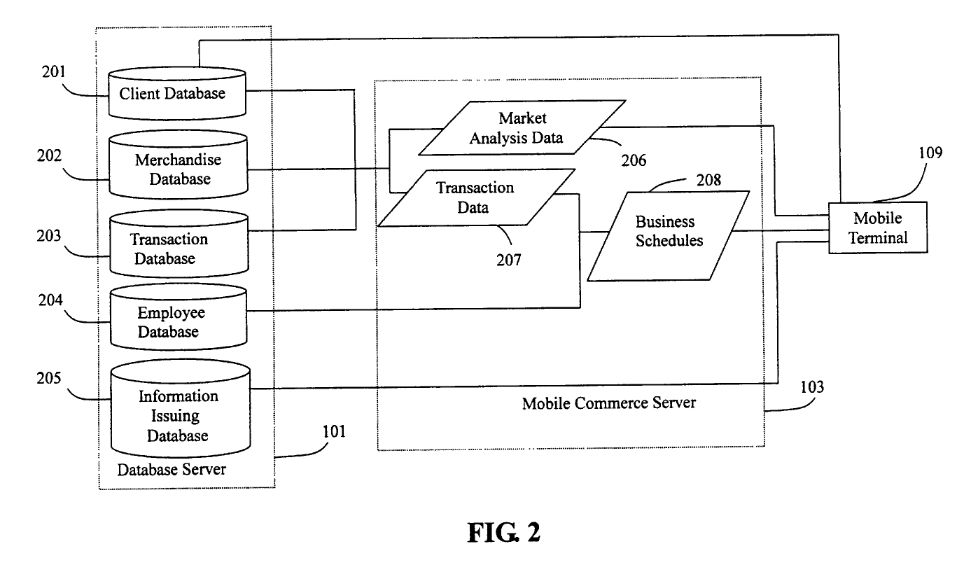

FIG. 2 is a schematic diagram of detailed infrastructure of the database server 101, and shows data communication between the database server 101, the mobile commerce server 103 and one mobile terminal 109. The database server 101 is a central database of an entire enterprise. The database server 101 comprises: a client database 201 for storing data on clients; a merchandise database 202 for storing data on merchandise sold by the enterprise; a transaction database 203 for storing transaction data on the enterprise; an employee database 204 for storing employee data including data on all sales representatives; and an information issuing database 205 for storing information issued by the enterprise. The application processing module 106 of the mobile commerce server 103 integrates data stored in the client database 201, data stored in the merchandise database 202, and data stored in the transaction database 203 to create transaction data 207 and market analysis data 206. The transaction data 207 and the market analysis data 206 are stored in the mobile commerce server 103. The transaction data 207 and data stored in the employee database 204 are processed by the application processing module 106 to generate business schedules 208 for sales representatives. The business schedules 208 are stored in the mobile commerce server 103. During the process of downloading data from the mobile commerce server 103, the business schedules 208, the market analysis data 206, data stored in the client database 201, and data stored in the information issuing database 205 are transferred to the mobile terminal 109 via the connecting module 104 of the mobile commerce server 103.

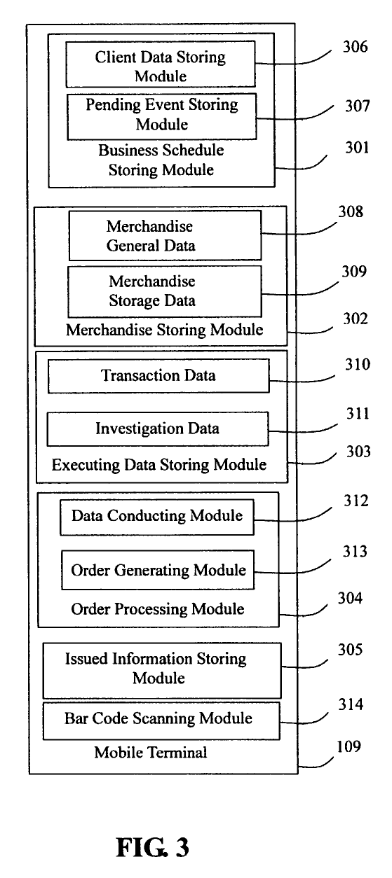

FIG. 3 is a schematic block diagram of function modules of one mobile terminal 109. The mobile terminal 109 comprises: a business schedule storing module 301 which is used to record work flow, and businesses or clients that a sales representative visits; a merchandise storing module 302 which is used to store all merchandise information on the enterprise as a reference for the sales representative to inquire of; an executing data storing module 303 which is used to record data on execution of commercial activities; an issued information storing module 305 which is used to store information on the enterprise's current news, merchandise shortage notes, and newly promoted products; a bar code scanning module 314 which is used to scan and identify various clients' bar codes which respectively represent various clients; and an order processing module 304 which is used to process data and generate orders.

The business schedule storing module 301 comprises a client data storing module 306, and a pending event storing module 307. The client data storing module 306 stores commercial activities information on clients, including client basic data, client ordering data and accounts receivable. The client basic data includes client name, address and phone number. The pending event storing module 307 is used to remind the sales representative of matters that need to be attended to. For instance, such matters may be orders that need conducting, collection of accounts receivable, and market investigation. The merchandise storing module 302 comprises merchandise general data 308 and merchandise storage data 309. The merchandise general data 308 includes basic merchandise data such as name, serial number and specification, merchandise price data and key merchandise data. The merchandise storage data 309 includes corresponding merchandise inventory volume and distribution information. The executing data storing module 303 stores transaction data 310 and investigation data 311. The information in the executing data storing module 303 is sent to the mobile commerce server 103, and is processed by the application processing module 106. The information in the database server 101 is updated accordingly. The order processing module 304 comprises a data conducting module 312 and an order generating module 313. The data conducting module 312 is used for processing merchandise data downloaded from the database server 101 and the client information system 110. The order generating module 313 is used to generate computer advisory orders, sales representative advisory orders and formal orders in accordance with the data processed by the data conducting module 312. All the data on orders is subsequently uploaded to the database server 101 for storage.

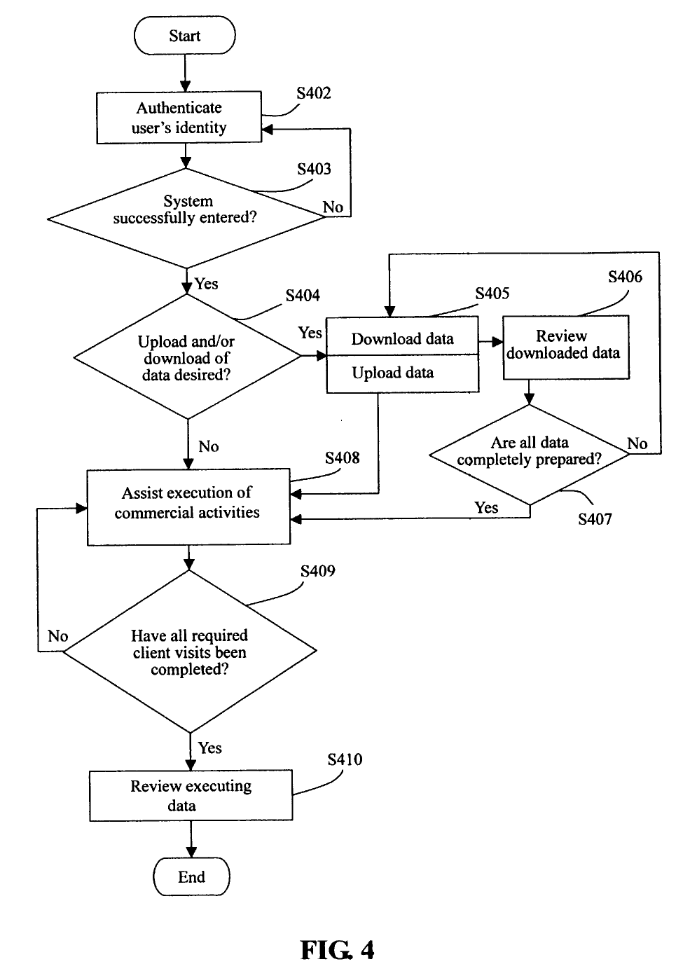

FIG. 4 is a flowchart of executing mobile commerce in accordance with a preferred embodiment of the present invention. Firstly, in step S402, before a user enters the system, the mobile terminal 109 authorizes access for the user. In step S403, if the user cannot successfully enter the system, then the procedure returns to step S402. If the user successfully enters the system, then in step S404, the mobile terminal 109 inquires whether or not the user wants to upload and/or download data. If the user does not want to upload or download data, then the procedure proceeds directly to step S408 described below. Otherwise, in step S405, the mobile terminal 109 downloads data including a business schedule from the mobile commerce server 103, and/or uploads data on execution of commercial activities already completed to the executing data storing module 303 of the mobile commerce server 103. These download and upload operations can be performed individually and separately. If the mobile terminal 109 only uploads data, then the procedure proceeds directly to step S408 described below. If the mobile terminal 109 downloads data, then in step S406, when all the data have been downloaded, the mobile terminal 109 displays the downloaded data and a summary prepared by the user of items needed by the user for executing commercial activities. The user compares the downloaded data with the needed items, and marks any outstanding needed items. Then, in step S407, the business schedule storing module 301 determines whether all the downloaded data are prepared having regard to the user's mark, if any. If the downloaded data are not prepared, then the procedure returns to step S405, and the outstanding wanted data are downloaded. If the downloaded data are prepared, then the procedure proceeds directly to step S408. In step S408, the actual commercial activities are performed, and the executing data storing module 303 records corresponding operations during the process of execution of the commercial activities. When the commercial activities are finished, in step S409 the business schedule storing module 301 determines whether all required visits to businesses such as clients have been completed. If all required client visits have not been completed, then the procedure returns to step S408 and the sales representative continues to visit other clients. If and when all required client visits have been completed, then in step S410, the executing data storing module 303 collects and analyzes all client visit information on the business schedule, and generates a consolidated report for the sales representative to review.

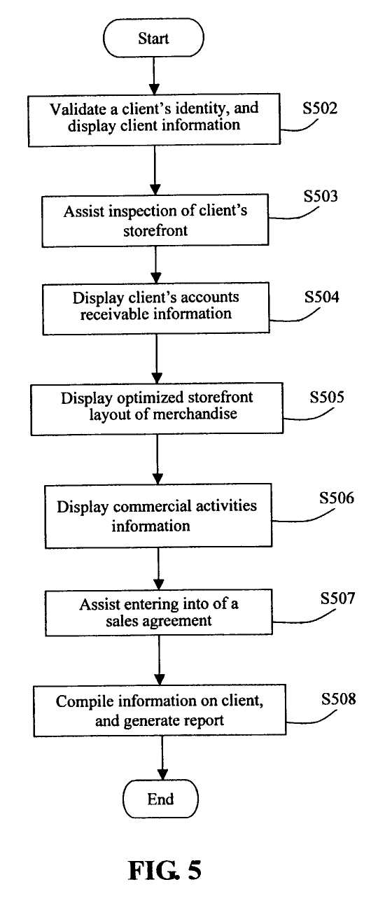

FIG. 5 is a flowchart of details of step S408 of FIG. 4, namely assisting execution of commercial activities. Firstly, in step S502 the mobile terminal 109 validates a client's identity, and displays corresponding client information. The client's identity can be validated by either scanning the client's bar code, or manually entering the client's name, code or other details. The client information includes basic information on the client such as name, address and phone number.

In step S503, the mobile terminal 109 assists the user in inspecting the client's storefront premises. Matters examined may include verification of the enterprise's merchandise inventory, checking of the client's merchandise information, investigation of merchandise prices, investigation of fake products, and compiling of questionnaires. The executing data storing module 303 records the client visit and noteworthy matters arising from the visit. All this information is transferred to the mobile commerce server 103, so that the next business schedule can be arranged. In step S504, the business schedule storing module 301 displays the client's accounts receivable information, and reminds the sales representative to collect any outstanding payments. In step S505, the application processing module 106 of the mobile server 103 computes a new optimized storefront layout of merchandise based on the enterprise's sales strategy, the client's current storefront layout, the client's previous storefront layouts, and previous storefront layouts by other clients. The new optimized storefront layout is stored in the business schedule storing module 301, and is displayed on the mobile terminal 109. The new optimized storefront layout is used to guide the client to adjust its layout of merchandise at its storefront premises. In step S506, the business schedule storing module 301 shows the enterprise's scheduled commercial activities on the mobile terminal 109. Such scheduled activities are used to assist the client to formulate its own sales strategy.

In step S507, the mobile terminal 109 assists the sales representative to enter into a sales agreement with the client. Firstly, the executing data storing module 303 automatically generates a sales order in accordance with verified merchandise inventory information and a merchandise sales record of the client. The sales representative modifies the order in light of consultations with the client. When a final order is created, the mobile terminal 109 displays a notice advising whether the total price of the order is within the client's credit allowance. If the client wants to return merchandise, the executing data storing module 303 records data on returned merchandise.

Finally, in step S508 the executing data storing module 303 compiles information on the client, and generates a report on the client for the sales representative to check. All such information and the report are sent to the mobile commerce server 103, and processed by the application processing module 106. Subsequently, the processed information is transferred to the database server 101, and the application processing module 106 updates all data stored in corresponding databases.

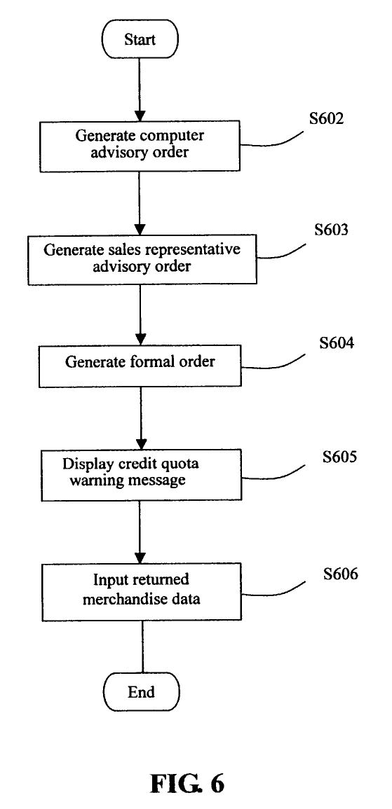

FIG. 6 is a flow chart of promoting merchandise. Firstly, the mobile terminal 109 downloads a client's current verified merchandise inventory data from the client information system 110, and scans key merchandise information and average weekly merchandise sales information. The key merchandise information includes merchandise serial number, merchandise category, merchandise quantity, and merchandise price. The average weekly merchandise sales information is calculating from sales history records. In step S602, after comparing the inventory data with the key merchandise information and the average weekly merchandise sales information, the mobile terminal 109 automatically generates a computer advisory order which includes order date, client code, sales representative code, merchandise quantity, merchandise name, merchandise price and total price of the order. In step S603, the sales representative amends the computer advisory order according to data downloaded from the client information system 110, to thus generate a sales representative advisory order. In step S604, the mobile terminal 109 generates and prints a formal order after the client confirms the category and quantity of merchandise specified in the sales representative advisory order. The formal order is stored in the executing data storing module 303, and sent to the mobile commerce server 103 to update data stored in the database server 101. In step S605, the mobile terminal 109 automatically determines whether the total price of the formal order is within the credit quota. If the total price of the formal order exceeds the credit quota, the mobile terminal 109 displays a credit quota warning message for the attention of the sales representative. In step S606, the mobile terminal 109 scans bar codes of returned merchandise with a bar code scanner, obtains merchandise serial numbers and merchandise names from downloaded merchandise basic data, and records the quantity and other details of returned merchandise. Such other details include client codes, merchandise serial numbers, merchandise names, merchandise comments and merchandise return dates. Finally, the returned merchandise information is uploaded to the mobile commerce server 103 and stored.

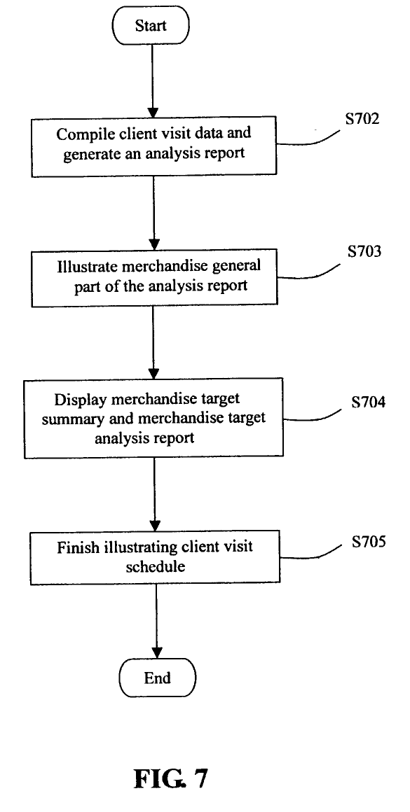

FIG. 7 is a flow chart of providing an analysis report. Firstly, in step S702, the mobile terminal 109 compiles all visit data on the client, and generates an analysis report in accordance with a target portfolio and cash receipts target data that are downloaded from the mobile commerce server 103. The analysis report includes a merchandise general part and a merchandise target completion part. The merchandise general part includes merchandise price survey data, merchandise questionnaire survey data, fake merchandise survey data, returned merchandise information, and a total amount of accounts receivable. The merchandise target completion data includes a merchandise target summary and merchandise target analysis data. In step S703, the mobile terminal 109 automatically displays the merchandise general part of the analysis report for the sales representative. In step S704, the mobile terminal 109 displays the merchandise target summary and the merchandise target analysis data in that order. Finally, in step S705, the client visit schedule finishes, and all data on the analysis report are stored in the executing data storing module 303.

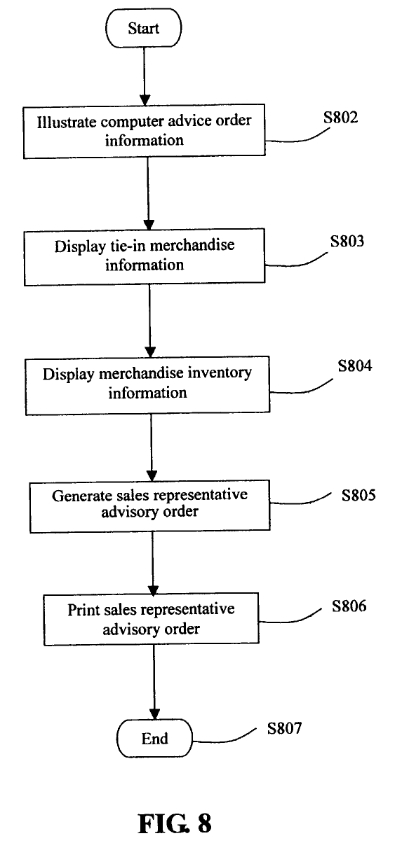

FIG. 8 is a flow chart of details of step S603 of FIG. 6, namely generating a sales representative advisory order. Firstly, in step S802, the mobile terminal 109 illustrates information on a computer advisory order as a graphic image. In step S803, the mobile terminal 109 downloads related merchandise information from the client information system 110 as a reference for the sales representative. The order processing module 304 processes data downloaded from the database server 101 and the data downloaded from the client information system 110. In step S804, merchandise inventory information is displayed for the sales representative to preview. In step S805, after the sales representative checks and/or modifies a quantity of the computer advisory order, the order processing module 304 generates a sales representative advisory order, and the data of the sales representative advisory order is stored in the executing data storing module 303. The sales representative advisory order includes order date, client code, sales representative code, merchandise name, merchandise quantity, merchandise price, and total price of the order. Finally, in step S806, the mobile terminal 109 prints the sales representative advisory order.

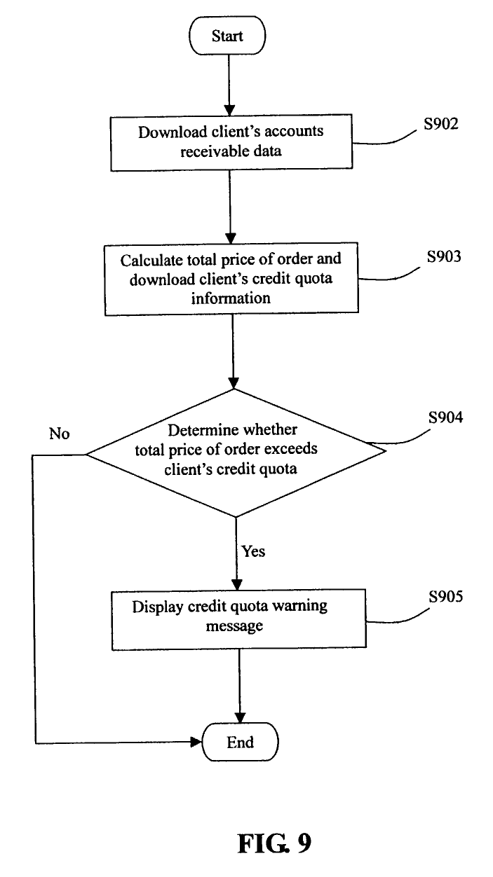

FIG. 9 is a flow chart of details of step S605 of FIG. 6, namely displaying a credit quota warning message. Firstly, in step S902, the mobile terminal 109 downloads a client's basic data and accounts receivable information from the client information system 110. In step S903, the order processing module 304 automatically calculates a total price of an order. Then the mobile terminal 109 downloads the client's credit quota information from the client information system 110. In step S904, the mobile terminal 109 automatically determines whether the total price of the order exceeds the client's credit quota. If the total price of the order does not exceed the credit quota, the procedure is finished. If the total price of the order exceeds the credit quota, then in step S905 the mobile terminal 109 displays a credit quota warning message for the attention of the sales representative.

Although various embodiments are described herein, it should be understood that they are not to be construed as limiting the present invention. Various changes, substitutions and alterations can be made therein by those skilled in the art without departing form the spirit and scope of the invention as defined by the appended claims.

What is claimed is:

1. A system for facilitating sales by way of mobile commerce, the system comprising:
a database server;
a mobile commerce server electronically linked with the database server for creating business visit schedules; and
at least one mobile terminal electronically linked with the mobile commerce server for downloading the business visit schedules from the mobile commerce server, the at least one mobile terminal comprising:
a business schedule storing module for storing the downloaded business visit schedules and for assisting arrangement of business visit schedules; and
an order processing module for processing data and creating orders; wherein
the mobile commerce server comprises an application processing module for generating business schedules in accordance with data stored in the database server, and for updating data stored in the database server in accordance with data sent from the at least one mobile terminal.

2. The system for facilitating sales by way of mobile commerce as claimed in claim 1, wherein the order processing module further comprises a data conducting module for processing merchandise data and an order generating module for generating orders.

3. The system for facilitating sales by way of mobile commerce as claimed in claim 1, wherein the at least one mobile terminal further comprises a bar code scanning module for identifying bar codes of clients.

4. A method for facilitating sales by way of mobile commerce, the method comprising the steps of:
(a) generating a computer advisory order in accordance with verified merchandise inventory information;
(b) generating a sales representative advisory order in accordance with merchandise data and merchandise inventory information which is downloaded from a client information system;
(c) generating a formal order in accordance with a quantity of merchandise and a category of merchandise which have been checked and/or modified; and
(d) displaying a credit quota warning message.

5. The method for facilitating sales by way of mobile commerce as claimed in claim 4, further comprising the step of:
scanning and comparing merchandise verification information, key merchandise information and merchandise average weekly sales records.

6. The method for facilitating sales by way of mobile commerce as claimed in claim 4, further comprising the step of:
recording data on returned merchandise.

7. The method for facilitating sales by way of mobile commerce as claimed in claim 5, wherein merchandise average weekly sales records are calculated according to a merchandise sales history record.

8. The method for facilitating sales by way of mobile commerce as claimed in claim 4, wherein step (b) further comprises the steps of:
(b1) illustrating computer advisory order information as a graphic image;
(b2) downloading related merchandise information and displaying the information;
(b3) processing the data downloaded from a database server and from client information system;
(b4) displaying merchandise inventory information; and
(b5) generating a sales representative advisory order according to modified merchandise quantity data.

9. The method for facilitating sales by way of mobile commerce as claimed in claim 4, further comprising the step of:
transmitting computer advisory order data, sales representative advisory order data and formal order data to the mobile commerce server.

10. The method for facilitating sales by way of mobile commerce as claimed in claim 4, wherein step (d) further comprises the step of:
downloading a client's credit quota information from the client information system.

11. The method for facilitating sales by way of mobile commerce as claimed in claim 4, further comprising the step of:
reading a bar code of returned merchandise with a bar code scanner.

12. The method for facilitating sales by way of mobile commerce as claimed in claim 8, further comprising the step of:
compiling all business visit information and generating an analysis report.

13. The method for facilitating sales by way of mobile commerce as claimed in claim 12, wherein the business visit information is downloaded from the database server.

14. The method for facilitating sales by way of mobile commerce as claimed in claim 12, wherein the analysis report includes a merchandise general analysis report and a merchandise target completion report.

15. The method for facilitating sales by way of mobile commerce as claimed in claim 14, wherein the merchandise general analysis report includes a merchandise price survey report, a merchandise questionnaire survey report, a fake merchandise survey report, a returned merchandise survey report and a total amount of accounts receivable.

16. A method for facilitating sales by way of mobile commerce, the method comprising the steps of:
(a) downloading basic information on a client and accounts receivable information from a client information system;
(b) calculating a total price of an order and downloading information on a credit quota of the client;
(c) determining whether the total price of the order exceeds the client's credit quota; and
(d) displaying a credit quota warning message if the total price of the order exceeds the client's credit quota.

17. A method of processing a purchase order for a sales representative being personally on a site of a customer who initiates said purchase order, comprising:
said sales representative equipped with a portable terminal linked to a center database via a mobile sever;
said sales representative generating an advisory order based upon a corresponding inventory shown in the database, if necessary;
the customer modifying the corresponding order, if necessary, based upon the sales representative's advisory order; and
said sales representative receiving a warning message from the database if such a latest order exceeds a credit quota of said customer.
